(19) United States
(12) Patent Application Publication
(10) Pub. No.: US 2020/0143764 A1
(43) Pub. Date: May 7, 2020

(54) DISPLAY PANEL AND DISPLAY DEVICE

(71) Applicant: Wuhan China Star Optoelectronics Semiconductor Display Technology Co., Ltd., Wuhan Hubei (CN)

(72) Inventor: Jie LIU, Wuhan Hubei (CN)

(73) Assignee: Wuhan China Star Optoelectronics Semiconductor Display Technology Co., Ltd., Wuhan Hubei (CN)

(21) Appl. No.: 16/326,205

(22) PCT Filed: Oct. 12, 2018
(86) PCT No.: PCT/CN2018/110140

§ 371 Date: Feb. 17, 2019

(30) Foreign Application Priority Data
Aug. 15, 2018 (CN) 201810927826.0

(51) Int. Cl. G09G 3/36

(52) U.S. Cl. CPC G09G 3/3677; G09G 2310/08; G09G 2320/0252

(57) ABSTRACT

Provided are a display panel and a display device, including: a plurality of scan lines; a plurality of sub-pixels; and a plurality of driving circuits; each of the driving circuits includes an enable output transistor; the driving circuit includes a first driving circuit and a second driving circuit, and when a number of the sub-pixels driven by the first driving circuit is smaller than a number of the sub-pixels driven by the second driving circuit, a width of the enable output transistor corresponding to the first driving circuit is smaller than a width of the enable output transistor corresponding to the second driving circuit.

### FIELD OF THE INVENTION

The present application relates to a display field, and more particularly to a display panel and a display device.

### BACKGROUND OF THE INVENTION

The GOA technology, i.e. the Gate Driver on Array technology can utilize the array manufacturing processes of the liquid crystal display panel to manufacture the driving circuit of the level scan lines on the substrate around the active area, to replace the external chip for accomplishing the driving of the level scan lines. In addition, as the display requirements of the display panel are more and more diversified, higher requirements are presented for the appearance of the display panel.

Irregular display panels appear, such as display devices with an R-angle, a slot or a notch and circular shaped display devices. For instance, the number of pixels per row at the notch is different from the number of pixels per row with no notch, and the loadings (resistance-capacitance loading) on the scan lines connected to different rows of pixels are different. Each group of driving circuits on the display panel controls one row of pixels through a scan line. At the notch, each group of driving circuits controls fewer pixels and possesses a smaller loading. With no notch, each group of driving circuits controls more pixels and possesses a larger loading. When the scan signal on the scan line is transmitted to the pixels of the display area, there is difference in driving signal delays corresponding to the respective rows of pixels, resulting in display abnormality. For instance, due to the difference in the driving signal delays, the charging period of the pixels of the irregular area and the charging period of the pixels of the non-irregular area are inconsistent, resulting in display non-uniformity.

### SUMMARY OF THE INVENTION

An objective of the present application is to provide a display panel and a display device for solving the problem of display abnormality due to different rows of the display panel having different pixels, and for improving the display effect.

The present application provides a display panel, including:

a plurality of scan lines located in a display area, wherein the plurality of scan lines extend along a first direction and are arranged in a second direction and a plurality of sub-pixels connected to the plurality of scan lines, wherein the first direction and the second direction intersect;

a plurality of driving circuits located in a non-display area around the display area, wherein each of the driving circuits is connected to the corresponding sub-pixels by one of the scan lines, and each of the driving circuits includes at least one enable output transistor, and the enable output transistor is configured to provide an enable scan signal to the sub-pixels corresponding to the driving circuit; wherein

the driving circuits include a first driving circuit and a second driving circuit, and when a number of the sub-pixels driven by the first driving circuit is smaller than a number of the sub-pixels driven by the second driving circuit, a width of the enable output transistor corresponding to the first driving circuit is smaller than a width of the enable output transistor corresponding to the second driving circuit;

the display area includes an irregular area and a non-irregular area, and a width of the enable output transistor of the driving circuit corresponding to the sub-pixels of the irregular area is smaller than a width of the enable output transistor of the driving circuit corresponding to the sub-pixels of the non-irregular area; the driving circuits are located on opposite sides of the non-display area.

In the display panel of the present application, widths of the enable output transistors in the respective driving circuits corresponding to the sub-pixels of the non-irregular area are equal.

In the display panel of the present application, the respective driving circuits are sequentially arranged along the second direction;

the irregular area includes a plurality of sub-irregular areas, and in the second direction, numbers of sub-pixels of rows in the respective sub-irregular areas are increased by area, and widths of the enable output transistors in the driving circuits corresponding to the sub-pixels of the respective sub-irregular areas are sequentially increased.

In the display panel of the present application, the display panel is a closed figure including at least one of a circle, an ellipse, a polygon and a figure including a circular arc.

In the display panel of the present application, a ratio of the number of the sub-pixels driven by the first driving circuit and the number of the sub-pixels driven by the second driving circuit is equal to a ratio of the width of the enabling output transistor corresponding to the first driving circuit and the width of the enable output transistor corresponding to the second drive circuit.

In the display panel of the present application, the enable output transistor is an N-type thin film transistor or a P-type thin film transistor.

In the display panel of the present application, the display panel further includes: a plurality of data lines located in the display area, wherein the plurality of data lines extend along the second direction and are arranged along the first direction, and the plurality of data lines are connected to the plurality of sub-pixels.

The present application further provides a display panel, including:

a plurality of scan lines located in a display area, wherein the plurality of scan lines extend along a first direction and are arranged in a second direction and a plurality of sub-pixels connected to the plurality of scan lines, wherein the first direction and the second direction intersect;

a plurality of driving circuits located in a non-display area around the display area, wherein each of the driving circuits is connected to the corresponding sub-pixels by one of the scan lines, and each of the driving circuits includes at least one enable output transistor, and the enable output transistor is configured to provide an enable scan signal to the sub-pixels corresponding to the driving circuit; wherein

the driving circuits include a first driving circuit and a second driving circuit, and when a number of the sub-pixels driven by the first driving circuit is smaller than a number of the sub-pixels driven by the second driving circuit, a width of the enable output transistor corresponding to the first driving circuit is smaller than a width of the enable output transistor corresponding to the second driving circuit.

In the display panel of the present application, the display area includes an irregular area and a non-irregular area, and a width of the enable output transistor of the driving circuit corresponding to the sub-pixels of the irregular area is smaller than a width of the enable output transistor of the driving circuit corresponding to the sub-pixels of the non-irregular area.

In the display panel of the present application, widths of the enable output transistors in the respective driving circuits corresponding to the sub-pixels of the non-irregular area are equal.

In the display panel of the present application, the respective driving circuits are sequentially arranged along the second direction;

the irregular area includes a plurality of sub-irregular areas, and in the second direction, numbers of sub-pixels of rows in the respective sub-irregular areas are increased by area, and widths of the enable output transistors in the driving circuits corresponding to the sub-pixels of the respective sub-irregular areas are sequentially increased.

In the display panel of the present application, the display panel is a closed figure including at least one of a circle, an ellipse, a polygon and a figure including a circular arc.

In the display panel of the present application, a ratio of the number of the sub-pixels driven by the first driving circuit and the number of the sub-pixels driven by the second driving circuit is equal to a ratio of the width of the enabling output transistor corresponding to the first driving circuit and the width of the enable output transistor corresponding to the second drive circuit.

In the display panel of the present application, the driving circuits are located on opposite sides of the non-display area.

In the display panel of the present application, the enable output transistor is an N-type thin film transistor or a P-type thin film transistor.

In the display panel of the present application, the display panel further includes: a plurality of data lines located in the display area, wherein the plurality of data lines extend along the second direction and are arranged along the first direction, and the plurality of data lines are connected to the plurality of sub-pixels.

The present application further provides a display device, including a display panel, wherein the display panel includes:

a plurality of scan lines located in a display area, wherein the plurality of scan lines extend along a first direction and are arranged in a second direction and a plurality of sub-pixels connected to the plurality of scan lines, wherein the first direction and the second direction intersect;

a plurality of driving circuits located in a non-display area around the display area, wherein each of the driving circuits is connected to the corresponding sub-pixels by one of the scan lines, and each of the driving circuits includes at least one enable output transistor, and the enable output transistor is configured to provide an enable scan signal to the sub-pixels corresponding to the driving circuit; wherein

the driving circuits include a first driving circuit and a second driving circuit, and when a number of the sub-pixels driven by the first driving circuit is smaller than a number of the sub-pixels driven by the second driving circuit, a width of the enable output transistor corresponding to the first driving circuit is smaller than a width of the enable output transistor corresponding to the second driving circuit.

In the display device of the present application, the display area includes an irregular area and a non-irregular area, and a width of the enable output transistor of the driving circuit corresponding to the sub-pixels of the irregular area is smaller than a width of the enable output transistor of the driving circuit corresponding to the sub-pixels of the non-irregular area.

In the display device of the present application, widths of the enable output transistors in the respective driving circuits corresponding to the sub-pixels of the non-irregular area are equal.

In the display device of the present application, the respective driving circuits are sequentially arranged along the second direction;

the irregular area includes a plurality of sub-irregular areas, and in the second direction, numbers of sub-pixels of rows in the respective sub-irregular areas are increased by area, and widths of the enable output transistors in the driving circuits corresponding to the sub-pixels of the respective sub-irregular areas are sequentially increased.

The benefits of the present application are: since the number of the sub-pixels driven by the first driving circuit is smaller than the number of the sub-pixels driven by the second driving circuit, the width of the enable output transistor corresponding to the first driving circuit is smaller than the width of the enable output transistor corresponding to the second driving circuit. When scan signals outputted by the different driving circuits are loaded onto pixels through the scan lines, delay time of the scan signals outputted by the first driving circuit to the corresponding scan lines (i.e., the delay time with loading) and delay time of the scan signals outputted by the second driving circuit to the corresponding scan lines (i.e., the delay time with loading) are equal or nearly equal. Namely, the delay times of the scan signals received by each row of pixels on the display panel are close, which can solve the problem that phase difference of the delay times of the scan signals on the scan lines of different areas is relatively larger, and the display abnormality occurs, thereby improving the display effect.

### BRIEF DESCRIPTION OF THE DRAWINGS

In order to more clearly illustrate the embodiments of the present invention and the prior art, the following figures will be described in the embodiments and the prior art are briefly introduced. It is obvious that the drawings are only some embodiments of the present application, those of ordinary skill in this field can obtain other figures according to these figures without paying the premise.

FIG. 1 is a structural diagram of a display panel according to an embodiment of the present application;

FIG. 2 is a structural diagram of another display panel according to an embodiment of the present application;

FIG. 3 is a specific circuit diagram of a first sub-driving circuit in a driving circuit according to an embodiment of the present application;

FIG. 4 is a specific circuit diagram of a second sub-driving circuit in a driving circuit according to an embodiment of the present application.

### DETAILED DESCRIPTION OF PREFERRED EMBODIMENTS

The liquid crystal display components provided by the embodiments of the present application are described in detail. The principles and implementations of the present application are described in the specific examples. The description of the above embodiments is only for helping to understand the present application. Meanwhile, those skilled in the art will be able to change the specific embodiments and the scope of the application according to the idea of the present application. In conclusion, the content of the specification should not be construed as limiting the present application. The following descriptions for the respective embodiments are specific embodiments capable of being implemented for illustrations of the present application with referring to appended figures. The terms of up, down, front, rear, left, right, interior, exterior, side, etcetera mentioned in the present application are merely directions of referring to appended figures. Thus, the used directional terms are used to describe and understand the present application, but the present invention is not limited thereto. In the figure, units with similar structures are denoted by the same reference numerals.

The embodiment of the present application provides a display panel, including: a plurality of scan lines located in a display area, wherein the plurality of scan lines extend along a first direction and are arranged in a second direction and a plurality of sub-pixels connected to the plurality of scan lines, wherein the first direction and the second direction intersect; a plurality of driving circuits located in a non-display area around the display area, wherein each of the driving circuits is connected to the corresponding sub-pixels by one of the scan lines, and each of the driving circuits includes at least one enable output transistor, and the enable output transistor is configured to provide an enable scan signal to the sub-pixels corresponding to the driving circuit; wherein the driving circuits include a first driving circuit and a second driving circuit, and when a number of the sub-pixels driven by the first driving circuit is smaller than a number of the sub-pixels driven by the second driving circuit, a width of the enable output transistor corresponding to the first driving circuit is smaller than a width of the enable output transistor corresponding to the second driving circuit. Specifically, the first driving circuit and the second driving circuit in the embodiment of the present application are only different in the number of sub-pixels which are driven; namely, in essence, the driving circuit mentioned in the embodiment of the present application may be the first driving circuit or the second driving circuit.

The width of the enable transistor mentioned in the embodiment of the present application refers to the width of a conductive channel of the enable transistor.

Furthermore, a ratio of the number of the sub-pixels driven by the first driving circuit and the number of the sub-pixels driven by the second driving circuit is equal to a ratio of the width of the enabling output transistor corresponding to the first driving circuit and the width of the enable output transistor corresponding to the second drive circuit.

Specifically, in the embodiment of the present invention, according to the numbers of the sub-pixels driven by the respective driving circuits in the display panel, the widths of the enable output transistors corresponding to the different driving circuits are controlled in the array process of the display panel, Thus, the issue of display abnormality caused by the different pixels of different rows of the display panel can be solved to improve the display effect.

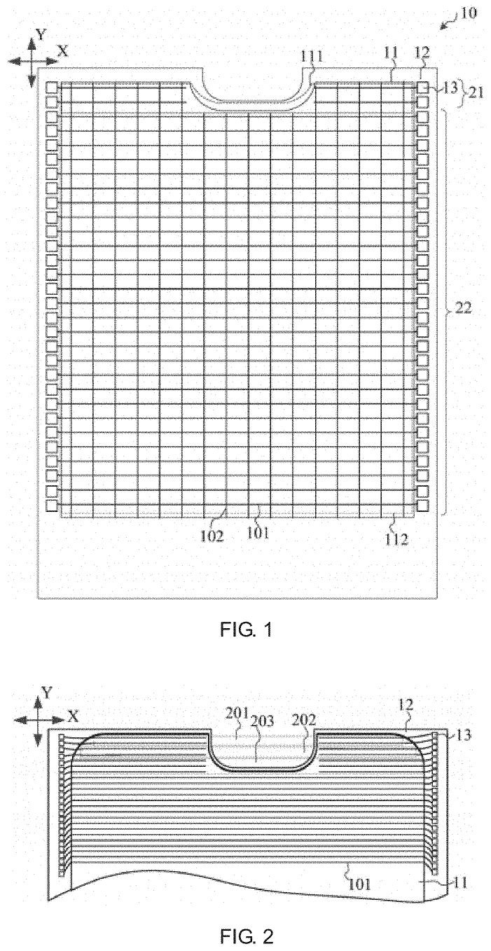

Please refer to FIG. 1. FIG. 1 is a structural diagram of a display panel according to an embodiment of the present application. As shown in FIG. 1, the display panel 10 includes:

a plurality of scan lines 101 and a plurality of data lines 102 located in a display area 11, wherein the plurality of scan lines 101 extend along a first direction X and are arranged in a second direction Y, and the plurality of data lines 102 extend along the second direction Y and are arranged in the first direction X, and a plurality of sub-pixels connected to the plurality of scan lines 101 and the plurality of data lines 102; wherein the first direction X and the second direction Y intersect; for instance, the first direction X and the second direction Y are perpendicular.

A plurality of driving circuits 13 is located in a non-display area 12 around the display area 11, and each of the driving circuits 13 is connected to the corresponding sub-pixels by one of the scan lines 101; the display area 11 includes an irregular area 111 and a non-irregular area 112, and a width of the enable output transistor of the driving circuit 13 corresponding to the sub-pixels of the irregular area 111 is smaller than a width of the enable output transistor of the driving circuit 13 corresponding to the sub-pixels of the non-irregular area 112.

Furthermore, a ratio of the number of the sub-pixels driven by one driving circuit 13 of the irregular area 111 and the number of the sub-pixels driven by one driving circuit 13 of the non-irregular area 112 is equal to a ratio of the width of the enabling output transistor corresponding to the one driving circuit 13 of the irregular area 111 and the width of the enable output transistor corresponding to the one driving circuit 13 of the non-irregular area 112.

In the embodiment of the present application, since the number of the sub-pixels driven by the respective driving circuits 13 of the non-irregular area 112 are the same, the widths of the enable output transistors corresponding to the respective driving circuits 13 of the non-irregular area 112 are equal.

In the embodiment of the present application, the respective driving circuits 13 are sequentially arranged along the second direction Y; the irregular area 111 includes a plurality of sub-irregular areas, and in the second direction Y, the numbers of sub-pixels of rows in the respective sub-irregular areas are increased by area, and widths of the enable output transistors in the driving circuits 13 corresponding to the sub-pixels of the respective sub-irregular areas are sequentially increased.

Specifically, referring to FIG. 2, FIG. 2 is a structural diagram of another display panel according to an embodiment of the present application. FIG. 2 shows a partial structure of the display panel. On the basis of the aforesaid embodiment, in the second direction Y, the driving circuits 13 are sequentially arranged;

the irregular area 111 includes a plurality of sub-irregular areas, such as a first sub-irregular area 201, a second sub-irregular area 202 and a third sub-irregular area 203. In the second direction Y, the numbers of sub-pixels of rows in the respective sub-irregular areas are increased by area, and widths of the enable output transistors in the driving circuits 13 corresponding to the sub-pixels of the respective sub-irregular areas are sequentially increased. The number of the sub-pixels of each row in the third sub-irregular area 203 is greater than the number of the sub-pixels of each row in the second sub-irregular area 202. The number of the sub-pixels of each row in the second sub-irregular area 202 is greater than the number of the sub-pixels of each row in the first sub-irregular area 201. The width of the enable output transistor of the driving circuit corresponding to the sub-pixels of the third sub-irregular area 203 is greater than the width of the enable output transistor of the driving circuit corresponding to the sub-pixels of the second sub-irregular area 202; the width of the enable output transistor of the driving circuit corresponding to the sub-pixels of the second sub-irregular area 202 is greater than the width of the enable output transistor of the driving circuit corresponding to the sub-pixels of the first sub-irregular area 201. Accordingly, it can be achieved that the delay time of the driving circuit corresponding to the sub-pixels of the first sub-irregular area 201 is greater than the delay time of the driving circuit corresponding to the sub-pixels of the second sub-irregular area 202, and the delay time of the driving circuit corresponding to the sub-pixels of the second sub-irregular area 202 is greater than the delay time of the driving circuit corresponding to the sub-pixels of the third sub-irregular area 203. The issue of display abnormality caused by that the number of sub-pixels of each row of the first sub-irregular area 201, the number of sub-pixels of each row of the second sub-irregular area 202 and the number of sub-pixels of each row of the third sub-irregular area 203 are different can be solved to improve the uniformity of the display and the display effect.

Specifically, one row of sub-pixels in the irregular area may constitute one sub-irregular area, or a plurality of adjacent rows of sub-pixels with equal number of sub-pixels per row may constitute one sub-irregular area. The division can be conducted according to the structure of the display panel.

In the embodiment of the present application, each of the driving circuits 13 includes at least one enable output transistor, and the enable output transistor is configured to provide an enable scan signal to the sub-pixels corresponding to the driving circuit 13. The width of the enable output transistor of the driving circuit 13 corresponding to the sub-pixels of the irregular area 111 is smaller than the width of the enable output transistor of the driving circuit 13 corresponding to the sub-pixels of the non-irregular area 112. The width of the transistor is a width of the conductive channel of the transistor. Generally, the larger the width of the transistor, the stronger the driving capability is. Namely, the stronger the capacity with loading, the less likely the output signal is affected by the loading.

Illustratively, the driving circuit provided according to the embodiment of the present application includes a first sub-driving circuit and a second sub-driving circuit, and the first sub-driving circuit and the second sub-driving circuit are used to jointly drive the display panel for operation. Specifically, the driving circuit mentioned in the embodiment of the present application includes a first sub-driving circuit and a second sub-driving circuit; namely, each of the first sub-driving circuit and the second sub-driving circuit according to the embodiment of the present application is a part of the driving circuit.

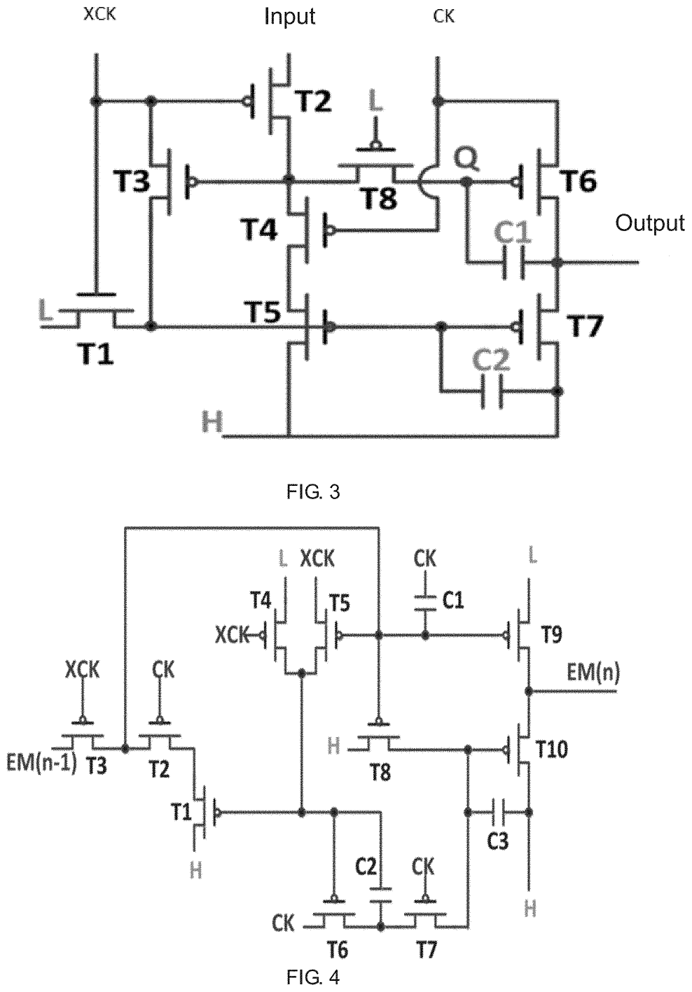

Please refer to FIG. 3. FIG. 3 is a specific circuit diagram of a first sub-driving circuit in a driving circuit according to an embodiment of the present application. As shown in FIG. 3, the first sub-driving circuit includes a first transistor T1, a second transistor T2, a third transistor T3, a fourth transistor T4, a fifth transistor T5, a sixth transistor T6, a seventh transistor T7, an eighth transistor T8, a first capacitor C1 and second capacitor C2. The sixth transistor T6 and the seventh transistor T7 are output transistors of the driving circuit, and the sixth transistor T6 and the seventh transistor T7 are turned on or off according to a voltage of a gate thereof. When the sixth transistor T6 is turned on, the signal inputted from the clock signal input end CK is transmitted to the output end of the driving circuit, and the seventh transistor T7 is not turned on at this time. Since only the sixth transistor T6 is turned on, the signal inputted from the clock signal input end is transmitted to the output end of the driving circuit, and then transmitted to the scan line, and the sub-pixel connected to the scan line is charged. Therefore, the sixth transistor T6 is the enable transistor of the driving circuit. When the sixth transistor T6 is turned on, a first enable scan signal is outputted to the scan line to control the sub-pixel for charging.

With FIG. 1, FIG. 2 and FIG. 3, the width of the enable output transistor of the first sub-drive circuit corresponding to the sub-pixels of the irregular area 111 is smaller than the width of the enable output transistor of the first sub-drive circuit corresponding to the sub-pixels of the non-irregular area 112.

Please refer to FIG. 4. FIG. 4 is a specific circuit diagram of a second sub-driving circuit in a driving circuit according to an embodiment of the present application. As shown in FIG. 4, the second sub-driving circuit includes a first transistor T1, a second transistor T2, a third transistor T3, a fourth transistor T4, a fifth transistor T5, a sixth transistor T6, a seventh transistor T7, an eighth transistor T8, a ninth transistor T9, a tenth transistor T10, a first capacitor C1 and second capacitor C2. The ninth transistor T9 and the tenth transistor T10 are output transistors of the driving circuit, and the ninth transistor T9 and the tenth transistor T10 are turned on or off according to a voltage of a gate thereof. When the ninth transistor T9 is turned on, the signal inputted from the low voltage signal input end L is transmitted to the output end of the driving circuit. When the tenth transistor T10 is turned on, the signal inputted from the high voltage signal input end H is transmitted to the output end of the driving circuit. Since only the tenth transistor T10 is turned on, the signal inputted from the high voltage signal input end is transmitted to the output end of the driving circuit, and then transmitted to the scan line, and the sub-pixel connected to the scan line is charged. Therefore, the tenth transistor T10 is the enable transistor of the driving circuit. When the tenth transistor T10 is turned on, a second enable scan signal is outputted to the scan line to control the sub-pixel for charging.

With FIG. 1, FIG. 2 and FIG. 4, the width of the enable output transistor of the second sub-driver circuit corresponding to the sub-pixels of the irregular area 111 and the width of the enable output transistor of the second sub-drive circuit corresponding to the sub-pixels of the non-irregular area 112 are not limited herein. Preferably, the width of the enable output transistor of the second sub-driver circuit corresponding to the sub-pixels of the irregular area 111 is smaller than the width of the enable output transistor of the second sub-drive circuit corresponding to the sub-pixels of the non-irregular area 112.

Specifically, the enable output transistor in the embodiment of the present application may be an N-type thin film transistor or a P-type thin film transistor.

Continue referring to FIG. 1 and FIG. 3, the driving circuit 13 of the first area 21 corresponds to the sub-pixels of the irregular area 111; the driving circuit 13 of the second area 22 corresponds to the sub-pixels of the non-irregular area 112. The width of the enable output transistor of the driving circuit 13 corresponding to the sub-pixels of the irregular area 111 is smaller than the width of the enable output transistor of the driving circuit 13 corresponding to the sub-pixels of the non-irregular area 112. Namely, the width of the sixth transistor T6 in the driving circuit 13 of the first area 21 is smaller than the width of the sixth transistor T6 in the driving circuit 13 of the second area 22. The width of the driving circuit 13 of the first area 21 is smaller. The output driving capability of the driving circuit of the first area 21 is relatively weak. Then, the delay time of the driving circuit 13 corresponding to the sub-pixels of the irregular area 111 is larger. The delay time of the driving circuit 13 corresponding to the sub-pixels of the irregular area 111 will be larger than the delay time of the driving circuit 13 corresponding to the sub-pixels of the non-irregular area 112. The problem of display non-uniformity caused by the different numbers of the sub-pixels of the respective rows for the irregular area and the non-irregular area can be solved to improve the display effect.

Please continue referring to FIG. 1, the driving circuits may be located on opposite sides of the non-display area. The irregular area 111 shown in FIG. 1 has a notch. The scan lines 111 are disconnected at the notch. The driving circuits 13 are located on opposite sides of the non-display area 12 to achieve providing scan signals to the scan lines 101 of the irregular area 111.

In the embodiment of the present application, the display panel may be a closed figure including at least one of a circle, an ellipse, a polygon and a figure including a circular arc. For instance, the irregular display panel in the embodiment of the present invention can be a display panel with an R-angle, a slot or a notch, or a circular shaped display panel.

The embodiment of the present application further provides a display device, which includes the foregoing display panel. For details, refer to the above, and no further details are provided herein.

In summary, although the above preferred embodiments of the present application are disclosed, the foregoing preferred embodiments are not intended to limit the invention, those skilled in the art can make various kinds of alterations and modifications without departing from the spirit and scope of the present application. Thus, the scope of protection of the present application is defined by the scope of the claims.

What is claimed is:

1. A display panel, including:
a plurality of scan lines located in a display area, wherein the plurality of scan lines extend along a first direction and are arranged in a second direction and a plurality of sub-pixels connected to the plurality of scan lines, wherein the first direction and the second direction intersect;
a plurality of driving circuits located in a non-display area around the display area, wherein each of the driving circuits is connected to the corresponding sub-pixels by one of the scan lines, and each of the driving circuits includes at least one enable output transistor, and the enable output transistor is configured to provide an enable scan signal to the sub-pixels corresponding to the driving circuit; wherein
the driving circuits include a first driving circuit and a second driving circuit, and when a number of the sub-pixels driven by the first driving circuit is smaller than a number of the sub-pixels driven by the second driving circuit, a width of the enable output transistor corresponding to the first driving circuit is smaller than a width of the enable output transistor corresponding to the second driving circuit;
the display area includes an irregular area and a non-irregular area, and a width of the enable output transistor of the driving circuit corresponding to the sub-pixels of the irregular area is smaller than a width of the enable output transistor of the driving circuit corresponding to the sub-pixels of the non-irregular area; the driving circuits are located on opposite sides of the non-display area.

2. The display panel according to claim 1, wherein widths of the enable output transistors in the respective driving circuits corresponding to the sub-pixels of the non-irregular area are equal.

3. The display panel according to claim 1, wherein the respective driving circuits are sequentially arranged along the second direction;
the irregular area includes a plurality of sub-irregular areas, and in the second direction, numbers of sub-pixels of rows in the respective sub-irregular areas are increased by area, and widths of the enable output transistors in the driving circuits corresponding to the sub-pixels of the respective sub-irregular areas are sequentially increased.

4. The display panel according to claim 1, wherein the display panel is a closed figure including at least one of a circle, an ellipse, a polygon and a figure including a circular arc.

5. The display panel according to claim 4, wherein a ratio of the number of the sub-pixels driven by the first driving circuit and the number of the sub-pixels driven by the second driving circuit is equal to a ratio of the width of the enabling output transistor corresponding to the first driving circuit and the width of the enable output transistor corresponding to the second drive circuit.

6. The display panel according to claim 1, wherein the enable output transistor is an N-type thin film transistor or a P-type thin film transistor.

7. The display panel according to claim 1, further including: a plurality of data lines located in the display area, wherein the plurality of data lines extend along the second direction and are arranged along the first direction, and the plurality of data lines are connected to the plurality of sub-pixels.

8. A display panel, including:
a plurality of scan lines located in a display area, wherein the plurality of scan lines extend along a first direction and are arranged in a second direction and a plurality of sub-pixels connected to the plurality of scan lines, wherein the first direction and the second direction intersect;
a plurality of driving circuits located in a non-display area around the display area, wherein each of the driving circuits is connected to the corresponding sub-pixels by one of the scan lines, and each of the driving circuits includes at least one enable output transistor, and the enable output transistor is configured to provide an enable scan signal to the sub-pixels corresponding to the driving circuit; wherein
the driving circuits include a first driving circuit and a second driving circuit, and when a number of the sub-pixels driven by the first driving circuit is smaller than a number of the sub-pixels driven by the second driving circuit, a width of the enable output transistor corresponding to the first driving circuit is smaller than a width of the enable output transistor corresponding to the second driving circuit.

9. The display panel according to claim 8, wherein the display area includes an irregular area and a non-irregular area, and a width of the enable output transistor of the driving circuit corresponding to the sub-pixels of the irregular area is smaller than a width of the enable output transistor of the driving circuit corresponding to the sub-pixels of the non-irregular area.

10. The display panel according to claim 9, wherein widths of the enable output transistors in the respective driving circuits corresponding to the sub-pixels of the non-irregular area are equal.

11. The display panel according to claim 9, wherein the respective driving circuits are sequentially arranged along the second direction;
the irregular area includes a plurality of sub-irregular areas, and in the second direction, numbers of sub-pixels of rows in the respective sub-irregular areas are increased by area, and widths of the enable output transistors in the driving circuits corresponding to the sub-pixels of the respective sub-irregular areas are sequentially increased.

12. The display panel according to claim 9, wherein the display panel is a closed figure including at least one of a circle, an ellipse, a polygon and a figure including a circular arc.

13. The display panel according to claim 12, wherein a ratio of the number of the sub-pixels driven by the first driving circuit and the number of the sub-pixels driven by the second driving circuit is equal to a ratio of the width of the enabling output transistor corresponding to the first driving circuit and the width of the enable output transistor corresponding to the second drive circuit.

14. The display panel according to claim 8, wherein the driving circuits are located on opposite sides of the non-display area.

15. The display panel according to claim 8, wherein the enable output transistor is an N-type thin film transistor or a P-type thin film transistor.

16. The display panel according to claim 8, further including: a plurality of data lines located in the display area, wherein the plurality of data lines extend along the second direction and are arranged along the first direction, and the plurality of data lines are connected to the plurality of sub-pixels.

17. A display device, including a display panel, wherein the display panel includes:
a plurality of scan lines located in a display area, wherein the plurality of scan lines extend along a first direction and are arranged in a second direction and a plurality of sub-pixels connected to the plurality of scan lines, wherein the first direction and the second direction intersect;
a plurality of driving circuits located in a non-display area around the display area, wherein each of the driving circuits is connected to the corresponding sub-pixels by one of the scan lines, and each of the driving circuits includes at least one enable output transistor, and the enable output transistor is configured to provide an enable scan signal to the sub-pixels corresponding to the driving circuit; wherein
the driving circuits include a first driving circuit and a second driving circuit, and when a number of the sub-pixels driven by the first driving circuit is smaller than a number of the sub-pixels driven by the second driving circuit, a width of the enable output transistor corresponding to the first driving circuit is smaller than a width of the enable output transistor corresponding to the second driving circuit.

18. The display device according to claim 17, wherein the display area includes an irregular area and a non-irregular area, and a width of the enable output transistor of the driving circuit corresponding to the sub-pixels of the irregular area is smaller than a width of the enable output transistor of the driving circuit corresponding to the sub-pixels of the non-irregular area.

19. The display device according to claim 18, wherein widths of the enable output transistors in the respective driving circuits corresponding to the sub-pixels of the non-irregular area are equal.

20. The display device according to claim 18, wherein the respective driving circuits are sequentially arranged along the second direction;
the irregular area includes a plurality of sub-irregular areas, and in the second direction, numbers of sub-pixels of rows in the respective sub-irregular areas are increased by area, and widths of the enable output transistors in the driving circuits corresponding to the sub-pixels of the respective sub-irregular areas are sequentially increased.
